(19) United States
(12) Patent Application Publication
(10) Pub. No.: US 2002/0190505 A1
(43) Pub. Date: Dec. 19, 2002

(54) Airbag covering provided with a specified rupture line and method for the production thereof

(76) Inventors: Ulf Feistel, Laasdorf (DE); Norbert Preuss, Jena (DE); Wolfgang Taenzer, Jena (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/130,947

(22) PCT Filed: Sep. 10, 2001
(86) PCT No.: PCT/DE01/03488

(30) Foreign Application Priority Data
Sep. 27, 2000 (DE) 100 48 636.3

(51) Int. Cl. B60R 21/20

(52) U.S. Cl. 280/728.3

(57) ABSTRACT

An airbag cover is defined by a predetermined breaking line which is introduced into a shaped flat material in a recessed manner. The recesses are achieved by removing material by means of laser radiation. According to the invention, the flat material is provided with a barrier layer. The barrier layer, by reason of its material properties, has greater resistance to removal of material by laser action than the material of the rest of the flat material. The recesses made by removing material extend along the predetermined breaking line in the flat material up to the barrier layer. The barrier layer makes it possible to produce a predetermined breaking line by means of laser machining which allows an exact residual wall thickness of the airbag cover in the area of the predetermined breaking line, so that the tearing strength can be adjusted very accurately, which is critically important for a reliable deployment of an airbag. Further, a method for the efficient production of an airbag cover of this type is indicated.

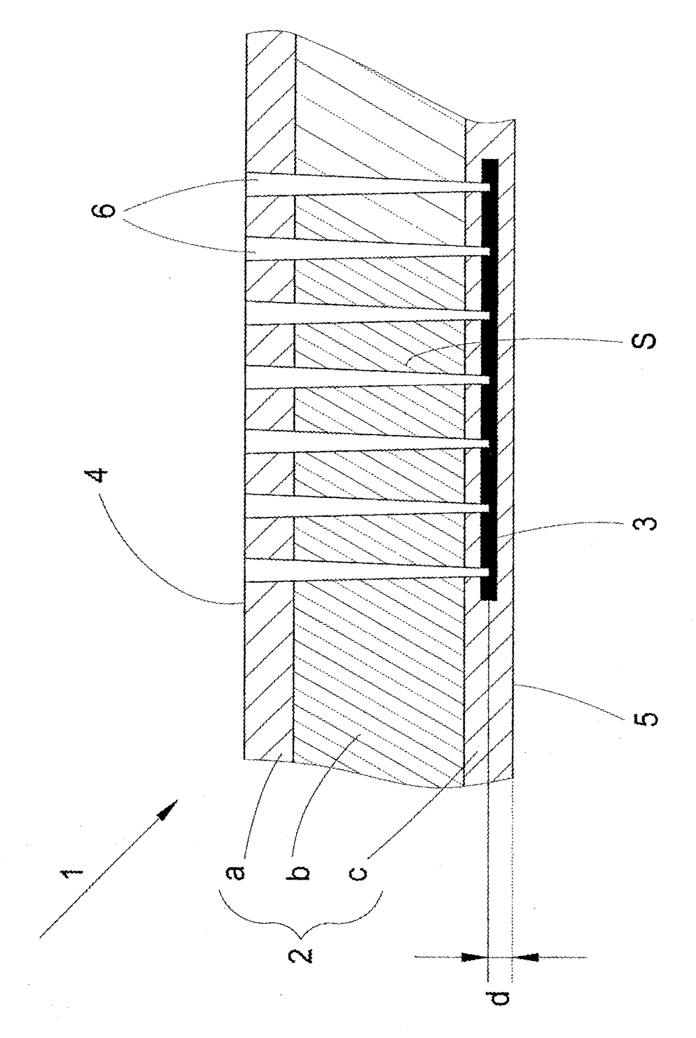

The invention is directed to an airbag cover which is integrated in a flat material that has been shaped to form a dashboard console, for example, and whose contour is defined by a predetermined breaking line (S) that has been introduced into the flat material in a recessed manner. The invention is further directed to a method for producing an airbag cover of this kind.

In modern motor vehicles, airbags for protecting the passengers of a vehicle in the event of a crash are currently accommodated not only in the steering wheel but also in other positions, for example, in a console or behind a side paneling. For cosmetic reasons, the airbags are integrated in the interior fittings of the vehicle as unobtrusively as possible. At the same time, it must be ensured that they can unfold or deploy in the desired manner when required and carry out their protective function.

A conventional possibility for accommodating the airbag consists in that the airbag modules or airbag subassemblies are arranged behind separately manufactured covers which are fitted into cutouts in the interior fittings and which are removed in the opening direction when the airbags deploy.

Further, it is known to form airbag covers integral with a paneling element. In this case, the covers are defined by predetermined breaking points formed in the area of the airbag module. For the cosmetic reasons mentioned above, however, this predetermined breaking point should not be visible on the one hand and, on the other hand, should be adequately resistant to inadvertent mechanical influences not relevant to airbag release. However, because it must be ensured that the airbag will nevertheless deploy in the desired manner in case of an accident, the predetermined breaking point must give way under the influence of a force which is very precisely determined with respect to direction and magnitude.

Therefore, when the predetermined breaking point is produced by laser machining, as is likewise known in the art, the laser energy must be precisely adapted to the cutting properties of the work material from which the interior vehicle paneling element in question is made as well as to the amount of material to be removed.

When a perforation produced by laser machining is provided as a predetermined breaking line and this perforation may not completely penetrate the thickness of the material of the paneling element, the laser beam that is used for machining must be monitored very exactly with respect to its intensity or with respect to the energy introduced into the material in order not to exceed a predetermined cutting depth and also in order that the predetermined cutting depth is reached.

In particular when the residual wall thickness is small, there is a danger that fluctuations in laser intensity will lead to unwanted penetration of laser radiation and, therefore, penetration of the perforation. In particular, in three-dimensionally contoured workpieces such as the consoles or similar airbag covers mentioned above, this requirement leads to high expenditure for controlling and monitoring the laser machining.

Aside from holes which are undesirable for cosmetic reasons, deviations in the cutting depth also lead to impermissible tolerances in the tearing strength or breaking strength of the predetermined breaking line. This must also be prevented for technical reasons relating to safety because, in order to ensure the protective action, it is necessary that the airbag deploys in a very precisely timed manner which, in turn, assumes a constant tearing strength or breaking strength of the predetermined breaking point. Excessive tolerances in tearing strength at the predetermined breaking line can lead to premature or retarded inflation of the airbag.

An airbag cover with a predetermined breaking line is known from DE 196 36 429 C1. In order to form the predetermined breaking line in a multiple-layer piece of flat material which is already in its final form, a pulsed laser beam is directed to the flat material from the side. In so doing, small amounts of the flat material evaporate at a material removal point or cutting location with each laser pulse, and the laser beam penetrates somewhat deeper into the flat material with each laser pulse. In order to prevent penetration through the opposite outer surface, a detector which is sensitive to laser radiation is arranged at that location.

When the boundary layer of the opposite outer surface is transparent to laser radiation, the detector receives the radiation even before the laser beam has penetrated through the entire thickness of the flat material. The detector then generates an output signal which causes the energy applied by the laser to be reduced in intensity or immediately switches off the laser.

The first signal emitted by the detector can switch the laser from continuous operation or from longer pulse lengths to short pulse lengths, for example. When the output signal reaches a first predetermined threshold value, the laser output is reduced. When a second threshold is reached, the laser radiation is stopped in order to prevent penetration. However, this method requires a relatively high expenditure on apparatus. In addition, it is hardly possible to achieve an exact residual wall thickness particularly with work materials which are poorly or inconsistently transparent.

With nontransparent work materials, microholes must be tolerated because the laser is immediately stopped as soon as the detector receives laser radiation and a signal is sent to the control circuit.

Further, EP 0 711 627 A3 discloses another method for producing an airbag cover with a predetermined breaking line in which the predetermined breaking line is produced by laser machining. In this case, holes are prevented in that the material thickness is initially measured at several places along the intended predetermined breaking line in a piece of flat material which has already been formed and this measurement is stored. The other thickness values along the planned line are then obtained by interpolation based on the stored measurements and these measurements are then likewise stored. Based on the measured and interpolated thickness values, the duration of irradiation and the laser output are predetermined for every position in such a way that a desired residual wall thickness remains in the material of the flat material piece. However, it is also hardly possible to maintain this residual wall thickness with sufficient accuracy in this method.

Proceeding from this prior art, it is the object of the invention to provide airbag covers of the type mentioned in the beginning in which the tearing behavior of the predetermined breaking line is adjusted within close tolerances.

This object is met in an airbag cover in which the flat material has, at least in the area of the predetermined breaking line, a barrier layer made from a material which, by reason of its properties, has greater resistance to removal of material by laser action than the rest of the flat material and in which the recesses in the material of the flat material extend along a predetermined breaking line up to the barrier layer.

The object of the invention is further met by a method for producing an airbag cover of the kind mentioned above, wherein, first, a flat material is produced which has, at least in the area in which the predetermined breaking line is to be introduced, a barrier layer comprising a material which, by reason of its properties, has a greater resistance to removal of material by laser action than the rest of the flat material, and then the predetermined breaking line is introduced in that recesses are made in the flat material by means of laser radiation at a plurality of adjacent locations, wherein the intensity of the laser radiation is selected in such a way in relation to the properties of the barrier layer and the rest of the flat material that only the flat material, but not the material of the barrier layer, is removed at each of these locations.

In this way, an exactly definable tearing behavior of the airbag cover can be achieved in a simple manner because an exact cutting depth by laser radiation is ensured during its production. The barrier layer which is provided at the flat material and which is insensitive to the cutting action of the laser radiation acts to a certain extent as a buffer for the occurring variations the laser radiation, so that expenditure on controlling means for maintaining a desired machining depth is kept low. Accordingly, a desired, preferably very uniform tearing behavior or breaking behavior can be realized along the predetermined breaking line. However, it is also possible to predefine a tearing behavior which changes along the line by taking into account the position of the barrier layer. The level of tearing force can be adapted to an optimal deployment of the airbag in a very precise manner in every case.

A sensing device for regulating the remaining residual wall thickness which was previously required, e.g., in the method according to DE 196 36 429 C1, is no longer needed. Rather, for purposes of control, a regulating circuit of this kind can be omitted entirely. Moreover, since the side that is not machined is protected against penetration, its visual appearance is unimpaired so that, in turn, waste due to unusable workpieces can be reduced during the production process. A considerable reduction in costs can be achieved in this way. The airbag covers are formed directly on the interior fittings of the vehicle such as dashboard consoles.

In an advantageous arrangement of the invention, all points on the predetermined breaking line at which a removal of material is carried out have the same residual wall thickness. This can be realized, for example, in that the barrier layer is provided at a uniform distance from the outer surface of the flat material remote of the machining side or directly on this outer surface. A constant tearing force which is determined substantially by the barrier layer and any flat material still remaining can also be achieved along the entire predetermined breaking line in this way.

When realized as perforations, the predetermined breaking line is preferably formed by a plurality of adjacent cutting locations in the form of holes, for example, round holes, which are limited in depth and have a small diameter.

In this way, the length of the portions of flat material not removed between two perforations influences the tearing force, but the tearing force can be maintained constant by uniform distances between the perforations or by a continuous slit along the predetermined breaking line.

An appreciable simplification of the production process can be achieved in that the radiation intensity during laser machining is adjusted to a constant level. This level is selected in such a way that the amount of material removed by laser cutting from the flat material piece is high, but only a little or none of the material is removed from the barrier layer. Because of the barrier layer, a location where material is to be removed can be acted upon for a longer period of time at constant radiation intensity without the risk that a hole will be formed. This time period is preferably selected based on the highest required cutting power.

When pulsed lasers are used, for example, they can be operated with a constant pulse duration. Generally, equal numbers of pulses are introduced at the locations where material is to be removed. Different predetermined cutting depths up to the barrier layer can also be adjusted, if required, by the quantity of pulses introduced in the cutting location.

A sensitive adjustment of pulse duration is not required because of the resistance of the barrier layer to cutting. However, the same number of pulses is preferably adjusted for all cutting locations, so that the method makes do without measuring thickness beforehand and can accordingly be implemented in a simple, flexible manner.

In another advantageous arrangement of the invention, the barrier layer is introduced only in the areas where laser machining will be carried out subsequently or along the predetermined breaking line in the flat material. This is particularly advantageous when the flat material will undergo further processing, particularly further shaping, before or after the predetermined breaking line is produced, and the barrier layer has increased resistance to deformation compared to the work material of the flat material. Of course, subsequent deformation or shaping must be carried out in such a way that there is no impairment of or unwanted effect on the tear strength along the predetermined breaking line.

In addition to the possibility of covering the flat material with the barrier layer over its entire surface, it is recommended in an alternative construction for the reasons stated above that the barrier layer is arranged in a pattern which covers only portions of the surface of the flat material piece. This pattern may be in the form of stripes, a grid or symmetric partial surfaces.

This procedure is suitable in particular for applications in which sections or blanks are cut out of the flat material piece that is already provided with a barrier layer and the laser machining for producing predetermined breaking points is generated at the section that is already cut out and shaped. By arranging the barrier layer in portions, there are a number of areas in which a predetermined breaking line can be produced.

The adjustment of the tearing strength along the predetermined breaking line can also be carried out, for example, by varying the thickness of the barrier layer. Another possibility consists in varying the position of the barrier layer in the thickness direction in the flat material, so that varying amounts of material remain in the latter after laser machining and, consequently, a greater or smaller residual wall thickness results.

As was indicated above, the tearing strength can be additionally uninfluenced by varying the position of the cutting locations along the laser machining line; it is also possible to vary the tearing strength along the predetermined breaking line by arranging cutting locations at irregular intervals. In addition, a tearing strength which varies along the predetermined breaking line because of the three-dimensional shape of the airbag cover can be compensated, or adjusted in a desired manner if required, by uneven spacing. In this way, the tearing force can be favorably adapted to the requirements of the deployment of the airbag even over curved or beaded surfaces.

In another advantageous arrangement of the method, a metal or nonmetal foil is pressed into the material of the flat material as a barrier layer, for example, by means of a stamping device, and is connected, e.g., glued, to it. A suitable adhesive can be used for this purpose, but it is also possible to use self-adhesive foils.

In another variant of this procedure, the foil is pressed into the material of the flat material piece before this material has hardened, so that the preferably metallic foil glues itself to the flat material. The barrier layer can also be arranged in or on the flat material in that a metal or nonmetal foil is connected, e.g., welded, to the material of the flat material by heating or ultrasound.

Further, it is possible for the barrier layer to be sprayed as a liquid, hardening polymer material onto the flat material or, conversely, to spray a polymer material as flat material onto the barrier layer. Liquid polymers which bind themselves to the material of the flat material are preferably used for this purpose. Otherwise, a binding agent is applied in addition.

The method according to the invention is not limited to flat material comprising an individual homogeneous work material. Rather, the flat material can also be produced by overlaying and connecting a plurality of layers, possibly of different materials. The barrier layer can then be arranged between two of these layers. The same technology as that used for connecting the individual layers of flat material can be used to arrange or embed the barrier layer.

The invention is described more fully in the following with reference to an embodiment example shown in the drawing. The drawing shows a partial view in section along a predetermined breaking line of an airbag cover.

The drawing shows an airbag cover 1 in the form of an interior paneling element for a motor vehicle. Only a section along a predetermined breaking line S is shown in the drawing. The airbag cover 1 is a molded article which is adapted to installation conditions, for example, a dashboard console, which has been formed from a flat material piece 2.

An integral cover is formed in the airbag cover 1, an airbag module fitting behind the latter. The shape of the cover is defined by the predetermined breaking line S. When the airbag module is released, the cover pops off due to the expansion of the airbag and the airbag cover 1 breaks along the predetermined breaking line S. This predetermined breaking line S is formed in the flat material piece 2 on the side of the airbag module and extends into the depth of the flat material piece 2 up to a barrier layer 3 which is embedded in the flat material piece 2. The barrier layer 3 is not penetrated along the predetermined breaking line S.

As can be seen from the drawing, the flat material piece 2 comprises three layers a, b and c. The barrier layer 3 is embedded in the third layer c of the flat material piece 2.

The predetermined breaking line S is formed by removing material from the flat material piece 2 through the action of a laser beam proceeding from the outer surface 4. The intensity of the laser radiation acting on the flat material piece 2 is controlled in such a way that material is removed up to the barrier layer 3 due to the applied energy, whereas only a small amount of material, if any, is removed from the barrier layer.

For this purpose, the flat material piece 2 and the barrier layer 3 comprise materials which have distinctly different resistance to laser machining. In particular, the resistance of the material of the flat material piece 2 is lower than that of the barrier layer 3.

Accordingly, during laser machining, the barrier layer 3 prevents penetration to the outer surface 5 of the flat material piece 2 located opposite the machined outer surface 4.

With respect to the flat material piece 2 in the embodiment example, the rigid carrier layer c on the passenger compartment side comprises polyurethane (PU) or a molded wood material, the middle layer b comprises a soft foam material such as polyethylene (PE) and layer a on the airbag module side comprises a plastic foil made, for example, of thermoplastic polyolefins (TPO).

To form the predetermined breaking line S, the flat material piece 2 is machined along a contour line of the cover by a CO₂ laser at a wavelength of 10.6 μm by producing a plurality of adjacent cutting locations 6 in the form of pocket holes one after the other along a contour line. The distance between adjacent cutting locations is 0.5 mm. As a result of the applied energy, the material of the flat material piece 2 evaporates at the cutting locations 6. However, no material is removed from the barrier layer 3 which is at a constant distance from the outer surface 5 of the flat material piece 2.

As can further be seen, a defined residual wall thickness d which is the same for all of the cutting locations 6 in the present embodiment example remains at every cutting location 6 along the predetermined breaking line S. The high accuracy of the residual wall thickness d enables a defined tearing strength or breaking strength within a close tolerance range. Moreover, the cutting locations 6 at the outer surface which is located opposite to the machined outer surface 4 and forms the outer side of the airbag cover is not visible.

As was already mentioned, the individual cutting locations 6 are formed by individual holes arranged at regular intervals along the predetermined breaking line S. In a modification of the embodiment example, these cutting locations 6 can also be formed as elongated holes extending in the direction of the predetermined breaking line S. Alternatively, a cutting location 6 can be provided as a continuous line along the predetermined breaking line S. The distance between the individual cutting locations 6 can also be varied in order to adjust specially defined tearing behavior along the predetermined breaking line. The latter does not necessarily run in a straight line, but can form an optionally curved shape, in particular, can be formed so as to be circumferentially closed.

Further, it is possible to arrange the barrier layer 3 at the outer surface 5 of the flat material piece 2, so that the residual wall thickness d is determined in this case solely by the thickness of the barrier layer 3. The barrier layer 3 can also be embedded in one of the two other layers a and b of the flat material piece 2 or can be inserted between two of the adjacent layers a, b and c shown in the drawing.

The thickness of the barrier layer 3 and its physical characteristics are determined depending on the requirements for the tearing strength or breaking strength of the predetermined breaking line S and the required energy level of the laser radiation for removal of material from the flat material piece 2 and for blocking the removal of material from the barrier layer 3.

As can be seen from the drawing, the barrier layer 3 extends only in the area of the predetermined breaking line S and parallel to the outer surface 5 of the flat material piece 2 that is not machined. In this case, the barrier layer 3 has been provided at the predetermined location for the predetermined breaking point corresponding to the required size and shape already during the production of the flat material piece. It can cover the entire cover or can also be arranged only directly below the predetermined breaking line S of the cover in the form of stripes.

However, it is also possible for the flat material piece 2 provided with the barrier layer 3 to be produced initially as a plate-like or foil-like blank or raw material on which barrier layer arrangement patterns are provided in the shape of stripes, grids or surfaces. This is particularly advantageous when the location and geometry of the predetermined breaking point has not yet been determined during production of the flat material piece 2 but it is not desirable to cover the entire surface with a barrier layer 3.

The desired molded article or a corresponding molded piece is then measured on the raw material in such a way that the desired predetermined breaking point is located in the area over the barrier layer 3.

The barrier layer 3 is advantageously arranged in the flat material piece 2 already during the production of the flat material. The technology used for this purpose is determined by the material characteristics of the work material of the barrier layer 3 and of the flat material.

Thus, it is possible, for example, that the barrier layer 3 is a metal or nonmetal foil in the form of a self-adhesive foil or also a foil with added glue is embedded and fixed as barrier layer 3 in the flat material piece 2 by means of a stamping device.

If required, this is carried out in one of the layers a, b or c of the flat material piece 2 already before the flat material piece 2 has cured; the foil then sticks to the work material of the flat material layer a, b or c b itself.

A further possibility, particularly for embedding nonmetallic foils, consists in welding on the barrier layer 3 by means of a heating plate or an ultrasound device.

The barrier layer 3 can also be realized by spraying an initially liquid polymer material onto a layer a, b or c of the flat material piece 2 which hardens after spraying on. If required, suitable adhesive agents are used in addition to join the materials of the flat material piece 2 and liquid polymer for the barrier layer 3.

Another technique for applying the barrier layer 3 consists in using a material which is similar to the material used for the flat material piece 2 or its layers a, b or c with respect to the system, so that the barrier layer 3 can be added or inserted like a layer a, b or c of the flat material piece 2.

To produce the airbag cover 1, a section or blank of the flat material piece 2 provided with the barrier layer 3 is provided with a predetermined breaking line S by means of laser machining. For this purpose, the airbag cover 1 which is already formed is moved relative to a laser beam by a feed device, e.g., a robot arm.

The radiation energy required for the removal of material along the predetermined breaking line S which is carried out in a pulsed manner or in a continuous manner is determined in relation to the specific material and laser. The laser machining course is carried out in a program-controlled manner, for example, in that the laser which is operated in a pulsed manner is positioned with its beam at a cutting location 6 and a predetermined quantity of laser pulses is triggered. The next cutting location 6 is then moved to. For this purpose, all of the cutting locations 6 are machined with the same number of pulses, each pulse having the same energy and the same duration. The quantity of pulses is governed by the greatest depth of material to be removed, so that removal of material up to the barrier layer 3 can be ensured even when there are variations in thickness in the flat material piece 2, and the desired residual wall thickness d can accordingly be reliably achieved at all locations.

With continuous operation, i.e., when the laser is switched on continuously, the laser beam is moved relative to the flat material 2 with a predetermined speed profile along the predetermined breaking line S. In order to generate the hole pattern shown in the drawing, the laser beam is kept at the individual cutting locations 6 for a predetermined dwell time whose duration is oriented to the longest time required for safely ensuring a complete removal of material up to the barrier layer 3 in all cases.

The airbag cover 1 produced in this manner is characterized by a tearing behavior and breaking behavior at the predetermined breaking point which can be adjusted very favorably and whose characteristics are reproducible in series manufacture within a very close range of tolerances. The expenditure on control and regulation during production is kept low in spite of the high accuracy of the tearing behavior and breaking behavior which can be achieved.

In a variant of the arrangement according to the invention which deviates from the embodiment example described above, a foil formed of a single-layer or multiple-layer flat material and a barrier layer is perforated in the manner described above and is then applied to a carrier layer that has already been formed three-dimensionally, and the airbag can be located in a special construction between the foil and the carrier layer.

1. Airbag cover which is integrated in shaped flat material and whose contour is defined by a predetermined breaking line (S) that has been introduced into the flat material in a recessed manner, wherein the flat material has, at least in the area of the predetermined breaking line (S), a barrier layer (3) made from a material which, by reason of its properties, has greater resistance to removal of material by laser action than the rest of the flat material, and wherein the recesses in the flat material extend along the predetermined breaking line (S) essentially up to the barrier layer (3).

2. Airbag cover according to claim 1, characterized in that the predetermined breaking line (S) is formed of a plurality of holes of limited depth which are introduced adjacent to one another in the flat material by means of laser radiation.

3. Airbag cover according to claim 1 or 2, characterized in that the barrier layer (3) is arranged on one of the outer surfaces (4, 5) of the flat material.

4. Airbag cover according to claim 1 or 2, characterized in that the barrier layer (3) is embedded in the flat material so as to extend parallel to the outer surfaces (4, 5) of the flat material.

5. Airbag cover according to one of claims 1 to 4, characterized in that the barrier layer (3) is provided only in an area following the predetermined breaking line (S),

6. Airbag cover according to one of claims 1 to 4, characterized in that the barrier layer (3) is provided only in the form of a pattern covering portions of the flat material, particularly in the form of stripes or grids.

7. Method for producing an airbag cover which is integrated in shaped flat material and whose contour is defined by a predetermined breaking line (S) that has been introduced into the depth of the flat material, characterized in that a flat material is produced initially which has, at least in the area in which the predetermined breaking line (S) is to be introduced, a barrier layer (3) comprising a material which, by reason of its properties, has a greater resistance to removal of material by laser action than the rest of the flat material, and the predetermined breaking line (S) is subsequently introduced in that recesses are made in the flat material by means of laser radiation at a plurality of adjacent locations, wherein the intensity of the laser radiation is selected in such a way in relation to the properties of the barrier layer (3) and the rest of the flat material that only the flat material, but not the material of the barrier layer (3), is removed at each of these locations.

8. Method according to claim 7, characterized in that the flat material which is provided with the barrier layer (3) is given the desired spatial shape, for example, the shape of a console, before introducing the plurality of recesses which, in their entirety, form the predetermined breaking line (S).

9. Method according to claim 7 or 8, characterized in that the barrier layer (3) is integrated in the flat material at a constant distance from the outer surface of the flat material on which the laser radiation acts.

10. Method according to claim 9, characterized in that the barrier layer (3) is arranged on the opposite outer surface of the flat material.

11. Method according to claim 9 or 10, characterized in that the barrier layer (3) is provided only in the areas that are subsequently machined by laser.

12. Method according to one of claims 7 to 11, characterized in that the intensity of the laser radiation is adjusted to a constant level.

13. Method according to one of claims 7 to 12, characterized in that the barrier layer (3) is provided in an arrangement pattern at the flat material which only partially covers the flat material, particularly in the shape of stripes or grids or symmetric partial surfaces.

14. Method according to one of claims 7 to 13, characterized in that the tearing strength of the predetermined breaking line (S) is adjusted through the selected thickness of the barrier layer (3).

15. Method according to one of claims 7 to 13, characterized in that the tearing strength of the predetermined breaking line (S) is adjusted through the selected position of the barrier layer (3) in the depth of the flat material.

16. Method according to one of claims 7 to 13, characterized in that the tearing strength of the predetermined breaking line (S) is adjusted through the selected distance between the adjacent recesses introduced by removal of material.

17. Method according to one of claims 7 to 16, characterized in that the flat material is essentially produced from a hardenable material, a metal or nonmetal foil serving as barrier layer (3) is pressed into this flat material before it has hardened and is joined to it.

18. Method according to one of claims 7 to 16, characterized in that a metal or nonmetal foil serves as barrier layer (3) and is connected to the material of the flat material by the action of heat or ultrasound.

19. Method according to one of claims 7 to 16, characterized in that a liquid, hardening polymer material serves as barrier layer (3) and is sprayed onto the flat material or, conversely, a polymer material serving as flat material is sprayed onto the barrier layer.

20. Method according to one of claims 7 to 19, characterized in that the flat material is produced by overlaying and connecting a plurality of layers of material, wherein the barrier layer (3) is arranged between two of these layers.
